(19) United States
(12) Patent Application Publication
(10) Pub. No.: US 2008/0028137 A1
(43) Pub. Date: Jan. 31, 2008

(54) Method and Apparatus For Refresh Management of Memory Modules

(76) Inventors: Keith R. Schakel, San Jose, CA (US); Suresh Natarajan Rajan, San Jose, CA (US); Michael John Sebastian Smith, Palo Alto, CA (US); David T. Wang, San Jose, CA (US)

Correspondence Address: PATTERSON & SHERIDAN, LLP;METARAM, 3040 POST OAK BLVD., HOUSTON, TX, 77026, US

(21) Appl. No.: 11/828,182

(22) Filed: Jul. 25, 2007

Related U.S. Application Data
(63) Continuation-in-part of application No. 11/584,179, filed on Oct. 20, 2006.
Application No. 11/584,179 is a continuation of application No. 11/524,811, filed on Sep. 20, 2006.
Application No. 11/524,811 is a continuation-in-part of application No. 11/461,439, filed on Jul. 31, 2006.
(60) Provisional application No. 60/823,229, filed on Aug. 22, 2006.

(51) Int. Cl. G06F 13/28

(52) U.S. Cl. 711/106

(57) ABSTRACT

One embodiment sets forth an interface circuit configured to manage refresh command sequences that includes a system interface adapted to receive a refresh command from a memory controller, clock frequency detection circuitry configured to determine the timing for issuing staggered refresh commands to two or more memory devices coupled to the interface circuit based on the refresh command received from the memory controller, and at least two refresh command sequence outputs configured to generate the staggered refresh commands for the two or more memory devices

### CROSS-REFERENCE TO RELATED APPLICATIONS

This application is a continuation-in-part of the U.S. patent application having Ser. No. 11/584,179, filed on Oct. 20, 2006, which is a continuation of the U.S. patent application having Ser. No. 11/524,811, filed on Sep. 20, 2006, which is a continuation-in-part of the U.S. patent application having Ser. No. 11/461,439, filed on Jul. 31, 2006. The current application also claims the priority benefit of U.S. Provisional Patent Application No. 60/823,229, filed on Aug. 22, 2006. The subject matter the above related applications is hereby incorporated herein by reference. However, insofar as any definitions, information used for claim interpretation, etc. from the above parent application conflict with that set forth herein, such definitions, information, etc. in the present application should apply.

### BACKGROUND OF THE INVENTION

1. Field of the Invention

Embodiments of the present invention generally relate to memory modules and, more specifically, to methods and apparatus for refresh management of memory modules.

2. Description of the Related Art

The storage capacity of memory systems is increasing rapidly due to various trends in computing, such as the introduction of 64-bit processors, multi-core processors, and advanced operating systems. Such memory systems may include one or more memory devices, such as, for example, dynamic random access memory (DRAM) devices. The cells of a typical DRAM device can retain data for a time period ranging from several seconds to tens of seconds, but to ensure that the data is properly retained and not lost, DRAM manufacturers usually specify a very low threshold for instituting a refresh operation. The specification for most modern memory systems containing DRAM devices is that the cells of the DRAM devices are refreshed once every 64 milliseconds. This means that each cell in a given DRAM device must be read out to the sense amplifier and then written back into the DRAM device at full signal strength once every 64 milliseconds. Furthermore, for some DRAM devices, to account for the effect of higher signal loss rate at higher temperature, the refresh rate is doubled when the device is operating above a standard temperature, typically above 85° C.

To simplify the task of ensuring that all DRAM cells are properly refreshed, most DRAM devices, including double data rate (DDR) and DDR2 synchronous DRAM (SDRAM) devices, have an internal refresh row address register that keeps track of the row identification (ID) of the last refreshed row. Typically, a memory controller sends a single refresh command to the DRAM device. Subsequently, the DRAM device increments the row ID in the refresh row address register and executes a sequence of standard steps (typically referred to a “row cycle”) to refresh the data contained in DRAM cells of all rows with the appropriate row ID's in all of the banks in the DRAM device.

With the advent of higher capacity DRAM devices, there are more cells to refresh. Thus, to properly refresh all DRAM cells in a higher capacity DRAM device, either the refresh operations need to be performed more frequently or more cells need to be refreshed with each refresh command. To simplify memory controller design, the choice made by DRAM device manufacturers and memory controller designers is to keep the frequency of refresh operations the same, but refresh more DRAM cells for each refresh operation for the higher capacity DRAM devices. However, one issue associated with the action of refreshing more DRAM devices for each refresh operation in the higher capacity DRAM devices is that larger electrical currents may be drawn by the higher capacity DRAM devices for each refresh operation.

As the foregoing illustrates, what is needed in the art are new techniques for refreshing multiple memory devices in a memory system. In particular, higher capacity DRAM devices that must refresh a large number of DRAM cells for each refresh command.

### SUMMARY OF THE INVENTION

One embodiment sets forth an interface circuit configured to manage refresh command sequences. The interface circuit includes a system interface adapted to receive a refresh command from a memory controller, clock frequency detection circuitry configured to determine the timing for issuing staggered refresh commands to two or more memory devices coupled to the interface circuit based on the refresh command received from the memory controller, and at least two refresh command sequence outputs configured to generate the staggered refresh commands for the two or more memory devices.

### BRIEF DESCRIPTION OF THE DRAWINGS

So that the manner in which the above recited features can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a multiple memory device system, according to one embodiment;

FIG. 1B illustrates a memory stack, according to one embodiment;

FIG. 1C illustrates a multiple memory device system, according to one embodiment that includes both an intelligent register and a intelligent buffer;

FIG. 2 illustrates a multiple memory device system, according to another embodiment;

FIG. 3 illustrates an idealized current draw as a function of time for a refresh cycle of a single memory device that executes two internal refresh cycles for each external refresh command, according to one embodiment;

FIG. 4A illustrates current draw as a function of time for two refresh cycles, started independently and staggered by a time period of half of the period of a single refresh cycle, according to another embodiment;

FIG. 4B illustrates voltage droop as a function of a stagger offset for two refresh cycles, according to one embodiment;

FIG. 5 illustrates the start and finish times of eight independent refresh cycles, according to one embodiment;

FIG. 6 illustrates a configuration of eight memory devices refreshed by two independently controlled refresh cycles starting at times t_{ST1} and t_{ST2}, respectively, according to one embodiment;

FIG. 7 illustrates a configuration of eight memory devices refreshed by four independently controlled refresh cycles starting at times t_{ST1}, t_{ST2}, t_{ST3} and t_{ST4}, respectively, according to another embodiment;

FIG. 8 illustrates a configuration of sixteen memory devices refreshed by eight independently controlled refresh cycles t_{ST1}, t_{ST2}, t_{ST3} and t_{ST4}, t_{ST5}, t_{ST6}, t_{ST7} and t_{ST8}, respectively, according to one embodiment;

FIG. 9 illustrates the octal configuration of the memory devices of FIG. 8 implemented within the multiple memory device system of FIG. 1A, according to one embodiment;

FIG. 10A is a flowchart of method steps for configuring, calculating, and generating the timing and assertion of two or more refresh commands, according to one embodiment;

FIG. 10B depicts a series of operations for calculating refresh stagger times for a given configuration.

FIG. 11 is a flowchart of method steps for configuring, calculating, and generating the timing and assertion of two or more refresh commands continuously and asynchronously, according to one embodiment;

FIG. 12 illustrates the interface circuit of FIG. 1A with refresh command outputs adapted to connect to a plurality of memory devices, such as the memory devices of FIG. 1A, according to one embodiment;

FIG. 13 is an exemplary illustration of a 72-bit ECC DIMM based upon industry-standard DRAM devices arranged vertically into stacks and horizontally into an array of stacks, according to one embodiment; and

FIG. 14 is a conceptual illustration of a computer platform including an interface circuit.

### DETAILED DESCRIPTION

Illustrative information will now be set forth regarding various optional architectures and features of different embodiments with which the foregoing frameworks may or may not be implemented, per the desires of the user. It should be strongly noted that the following information is set forth for illustrative purposes and should not be construed as limiting in any manner. Any of the following features may be optionally incorporated with or without the other features described.

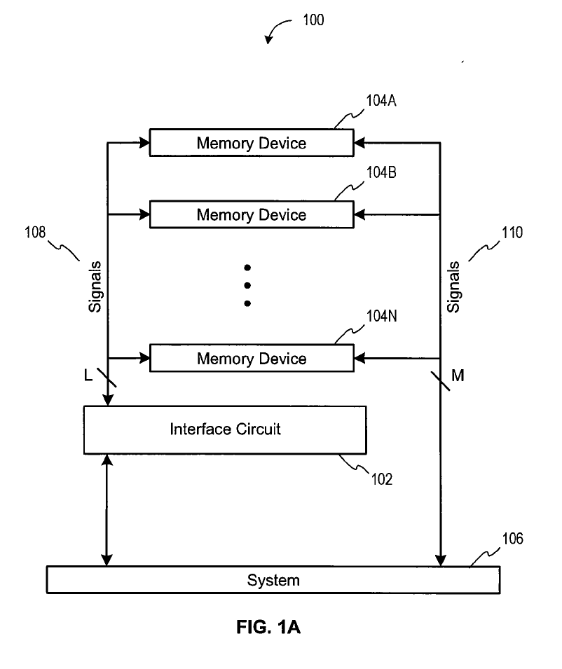

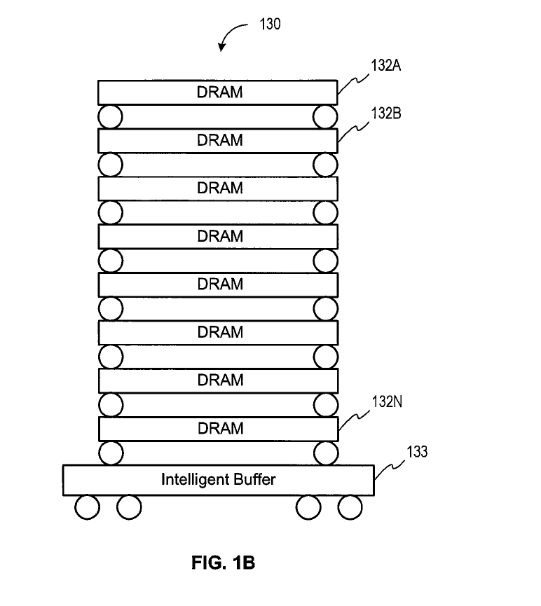

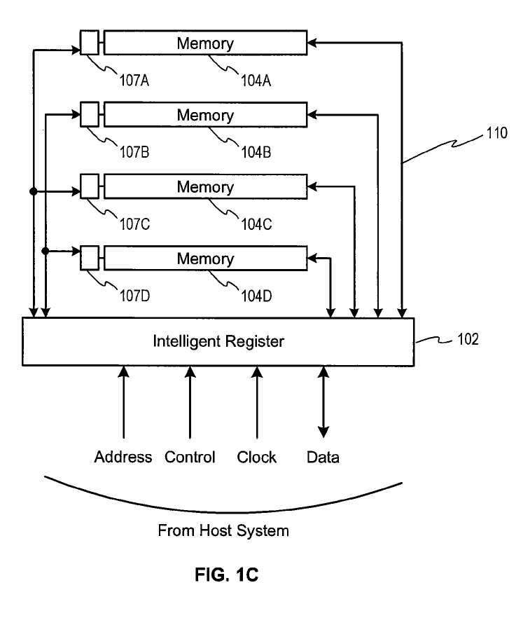

FIG. 1A illustrates a multiple memory device system 100, according to one embodiment. As shown, the multiple memory device system 100 includes, without limitation, a system device 106 coupled to an interface circuit 102, which is, in turn, coupled to a plurality of physical memory devices 104A-N. The memory devices 104A-N may be any type of memory devices. For example, in various embodiments, one or more of the memory devices 104A, 104B, 104N may include a monolithic memory device. For instance, such monolithic memory device may take the form of dynamic random access memory (DRAM). Such DRAM may take any form including, but not limited to synchronous (SDRAM), double data rate synchronous (DDR DRAM, DDR2 DRAM, DDR3 DRAM, etc.), quad data rate (QDR DRAM), direct RAMBUS (DRDRAM), fast page mode (FPM DRAM), video (VDRAM), extended data out (EDO DRAM), burst EDO (BEDO DRAM), multibank (MDRAM), synchronous graphics (SGRAM), and/or any other type of DRAM. Of course, one or more of the memory devices 104A, 104B, 104N may include other types of memory such as magnetic random access memory (MRAM), intelligent random access memory (IRAM), distributed network architecture (DNA) memory, window random access memory (WRAM), flash memory (e.g. NAND, NOR, or others, etc.), pseudostatic random access memory (PSRAM), wetware memory, and/or any other type of memory device that meets the above definition. In some embodiments, each of the memory devices 104A-N is a separate memory chip. For example, each may be a DDR2 DRAM.

In some embodiments, the any of the memory devices 104A-N may itself be a group of memory devices, or may be a group in the physical orientation of a stack. For example, FIG. 1B shows a memory device 130 which is comprised of a group of DRAM memory devices 132A-1 32N all electrically interconnected to each other and an intelligent buffer 133. In alternative embodiments, the intelligent buffer 133 may include the functionality of interface circuit 102. Further, the memory device 130 may be included in a DIMM (dual in-line memory module) or other type of memory module.

The memory devices 1032A-N may be any type of memory devices. Furthermore, in some embodiments, the memory devices 104A-N may be symmetrical, meaning each has the same capacity, type, speed, etc., while in other embodiments they may be asymmetrical. For ease of illustration only, three such memory devices are shown, 104A, 104B, and 104 N, but actual embodiments may use any plural number of memory devices. As will be discussed below, the memory devices 104A-N may optionally be coupled to a memory module (not shown), such as a DIMM.

The system device 106 may be any type of system capable of requesting and/or initiating a process that results in an access of the memory devices 104A-N. The system device 106 may include a memory controller (not shown) through which the system device 106 accesses the memory devices 104A-N.

The interface circuit 102 may include any circuit or logic capable of directly or indirectly communicating with the memory devices 104A-N, such as, for example, an interface circuit advanced memory buffer (AMB) chip or the like. The interface circuit 102 interfaces a plurality of signals 108 between the system device 106 and the memory devices 104A-N. The signals 108 may include, for example, data signals, address signals, control signals, clock signals, and the like. In some embodiments, all of the signals 108 communicated between the system device 106 and the memory devices 104A-N are communicated via the interface circuit 102. In other embodiments, some other signals, shown as signals 110, are communicated directly between the system device 106 (or some component thereof, such as a memory controller or an AMB) and the memory devices 104A-N, without passing through the interface circuit 102. In some embodiments, the majority of signals are communicated via the interface circuit 102, such that L>M.

As will be explained in greater detail below, the interface circuit 102 presents to the system device 106 an interface to emulate memory devices which differ in some aspect from the physical memory devices 104A-N that are actually present within system 100. The terms “emulating,” “emulated,” “emulation,” and the like are used herein to signify any type of emulation, simulation, disguising, transforming, converting, and the like, that results in at least one characteristic of the memory devices 104A-N appearing to the system device 106 to be different than the actual, physical characteristic of the memory devices 104A-N. For example, the interface circuit 102 may tell the system device 106 that the number of emulated memory devices is different than the actual number of physical memory devices 104A-N. In various embodiments, the emulated characteristic may be electrical in nature, physical in nature, logical in nature, pertaining to a protocol, etc. An example of an emulated electrical characteristic might be a signal or a voltage level. An example of an emulated physical characteristic might be a number of pins or wires, a number of signals, or a memory capacity. An example of an emulated protocol characteristic might be timing, or a specific protocol such as DDR3.

In the case of an emulated signal, such signal may be an address signal, a data signal, or a control signal associated with an activate operation, pre-charge operation, write operation, mode register set operation, refresh operation, etc. The interface circuit 102 may emulate the number of signals, type of signals, duration of signal assertion, and so forth. In addition, the interface circuit 102 may combine multiple signals to emulate another signal.

The interface circuit 102 may present to the system device 106 an emulated interface, for example, a DDR3 memory device, while the physical memory devices 104A-N are, in fact, DDR2 memory devices. The interface circuit 102 may emulate an interface to one version of a protocol, such as DDR2 with 3-3-3 latency timing, while the physical memory chips 104A-N are built to another version of the protocol, such as DDR with 5-5-5 latency timing. The interface circuit 102 may emulate an interface to a memory having a first capacity that is different than the actual combined capacity of the physical memory devices 104A-N.

An emulated timing signal may relate to a chip enable or other refresh signal. Alternatively, an emulated timing signal may relate to the latency of, for example, a column address strobe latency (t_{CAS}), a row address to column address latency (t_{RCD}), a row precharge latency (t_{RP}), an activate to precharge latency (t_{RAS}), and so forth.

The interface circuit 102 may be operable to receive a signal 107 from the system device 106 and communicate the signal 107 to one or more of the memory devices 104A-N after a delay (which may be hidden from the system device 106). In one embodiment, such a delay may be fixed, while in other embodiments, the delay may be variable. If variable, the delay may depend on e.g. a function of the current signal or a previous signal, a combination of signals, or the like. The delay may include a cumulative delay associated with any one or more of the signals. The delay may result in a time shift of the signal 107 forward or backward in time with respect to other signals. Different delays may be applied to different signals. The interface circuit 102 may similarly be operable to receive the signal 108 from one of the memory devices 104A-N and communicate the signal 108 to the system device 106 after a delay.

The interface circuit 102 may take the form of, or incorporate, or be incorporated into, a register, an AMB, a buffer, or the like, and may comply with JEDEC standards, and may have forwarding, storing, and/or buffering capabilities.

In one embodiment, the interface circuit 102 may perform multiple operations when a single operation is commanded by the system device 106, where the timing and sequence of the multiple operations are performed by the interface circuit 102 to the one or more of the memory devices without the knowledge of the system device 106. One such operation is a refresh operation. In the situation where the refresh operations are issued simultaneously, a large parallel load is presented to the power supply. To alleviate this load, multiple refresh operations could be staggered in time, thus reducing instantaneous load on the power supply. In various embodiments, the multiple memory device system 100 shown in FIG. 1A may include multiple memory devices 104A-N capable of being independently refreshed by the interface circuit 102.The interface circuit 102 may identify one or more of the memory devices 104A-N which are capable of being refreshed independently, and perform the refresh operation on those memory devices. In yet another embodiment, the multiple memory device system 100 shown in FIG. 1A includes the memory devices 104A-N which may be physically oriented in a stack, with each of the memory devices 104A-N capable to read/write a single bit. For example, to implement an eight-bit wide memory in a stack, eight one-bit wide memory devices 104A-N could be arranged in a stack of eight memory devices. In such a case, it may be desirable to control the refresh cycles of each of the memory devices 104A-N independently.

The interface circuit 102 may include one or more devices which together perform the emulation and related operations. In various embodiments, the interface circuit may be coupled or packaged with the memory devices 104A-N, or with the system device 106 or a component thereof, or separately. In one embodiment, the memory devices and the interface circuit are coupled to a DIMM. In alternative embodiments, the memory devices 104 and/or the interface circuit 102 may be coupled to a motherboard or some other circuit board within a computing device.

FIG. 1C illustrates a multiple memory device system, according to one embodiment. As shown, the multiple memory device system includes, without limitation, a host system device coupled to an host interface circuit, also known as an intelligent register circuit 102, which is, in turn, coupled to a plurality of intelligent buffer circuits 107A-107D, memory devices which is, in turn, coupled to a plurality of physical memory devices 104A-N.

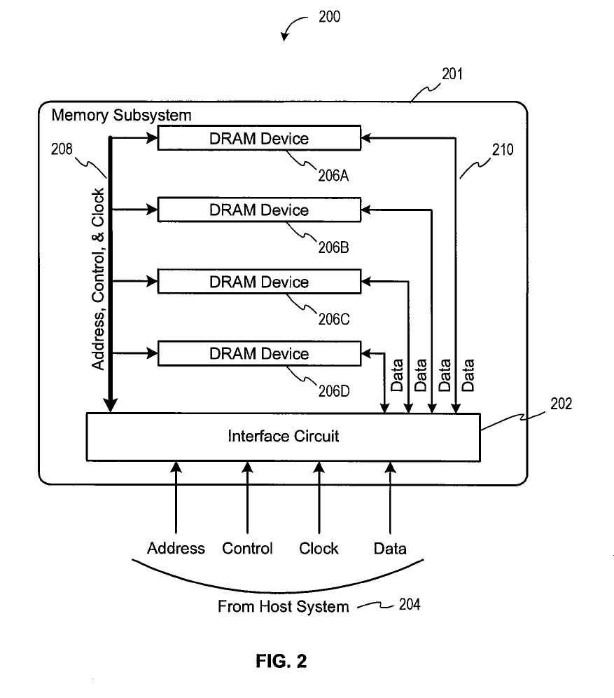

FIG. 2 illustrates a multiple memory device system 200, according to another embodiment. As shown, the multiple memory device system 200 includes, without limitation, a system device 204 which communicates address, control, and clock signals 208 and data signals 210 with a memory subsystem 201. The memory subsystem 201 includes an interface circuit 202, which presents the system device 204 with an emulated interface to emulated memory, and a plurality of physical memory devices, which are shown as DRAM 06A-D. In one embodiment, the DRAM devices 206A-D are stacked, and the interface circuit 202 is electrically disposed between the DRAM devices 206A-D and the system device 204. Although the embodiments described here show the stack consisting of multiple DRAM circuits, a stack may refer to any collection of memory devices (e.g., DRAM circuits, flash memory devices, or combinations of memory device technologies, etc.).

The interface circuit 202 may buffer signals between the system device 204 and the DRAM devices 206A-D, both electrically and logically. For example, the interface circuit 202 may present to the system device 204 an emulated interface to present the memory as though the memory comprised a smaller number of larger capacity DRAM devices, although, in actuality, the memory subsystem 201 includes a larger number of smaller capacity DRAM devices 206A-D. In another embodiment, the interface circuit 202 presents to the system device 204 an emulated interface to present the memory as though the memory were a smaller (or larger) number of larger capacity DRAM devices having more configured (or fewer configured) ranks, although, in actuality, the physical memory is configured to present a specified number of ranks. Although the FIG. 2 shows four DRAM devices 206A-D, this is done for ease of illustration only. In other embodiments, other numbers of DRAM devices may be used.

As also shown in FIG. 2, the interface circuit 202 is coupled to send address, control, and clock signals 208 to the DRAM devices 206A-D via one or more buses. In the embodiment shown, each of the DRAM devices 206A-D has its own, dedicated data path for sending and receiving data signals 210 to and from the interface circuit 202. Also, in the embodiment shown, the DRAM devices 206A-D are physically arranged on a single side of the interface circuit 202.

In one embodiment, the interface circuit 202 may be a part of the stack of the DRAM devices 206A-D. In other embodiments, the interface circuit 202 may be the bottom-most chip in the stack or otherwise disposed in or on the stack, or may be separate from the stack.

In some embodiments, the interface circuit 202 may perform operations whose relative timing and ordering are executed without the knowledge of the system device 204. One such operation is a refresh operation. The interface circuit 202 may identify one or more of the DRAM devices 206A-D that should be refreshed concurrently when a single refresh operation is issued by the system device 204 and perform the refresh operation on those DRAM devices. The methods and apparatuses capable of performing refresh operations on a plurality of memory devices are described later herein.

In general, it is desirable to manage the application of refresh operations such that the current draw and voltage levels remain within acceptable limits. Such limits may depend on the number and type of the memory devices being refreshed, physical design characteristics, and the characteristics of the system device (e.g., system devices 106, 204.)

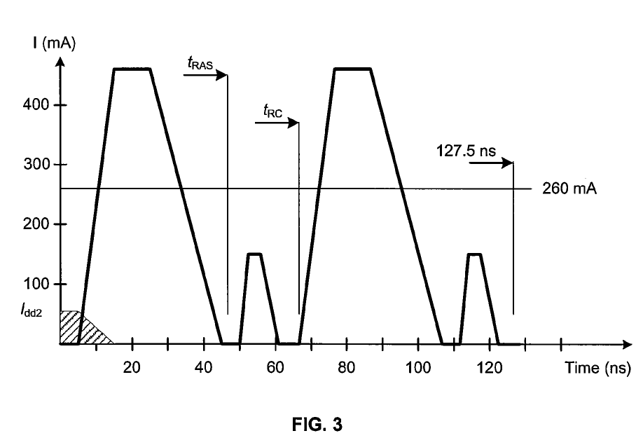

FIG. 3 illustrates an idealized current draw as a function of time for a refresh cycle of a single memory device that executes two internal refresh cycles for each external refresh command, according to one embodiment. The single memory device may be, for example, one of the memory devices 104A-N described in FIG. 1A or one of the DRAM devices described in FIG. 2.

FIG. 3 also shows several time periods, in particular, t_{RAS}, and t_{RC}. There is relatively less current draw during the 35 ns period between 40 ns and 75 ns as compared with the 35 ns period between 5 ns and 40 ns. Thus, in the specific case of managing refresh cycles independently for two memory devices (or independently for two banks), the instantaneous current draw can be minimized by staggering the beginning of the refresh cycles of the individual memory devices. In such an embodiment, the peak current draw for two independent, staggered refresh cycles of the two memory devices is reduced by starting the second refresh cycle at about 30 ns. However, in practical (non-idealized) systems, the optimal start time for a second or any subsequent refresh cycle may be a function of time as well as a function of many variables other than time.

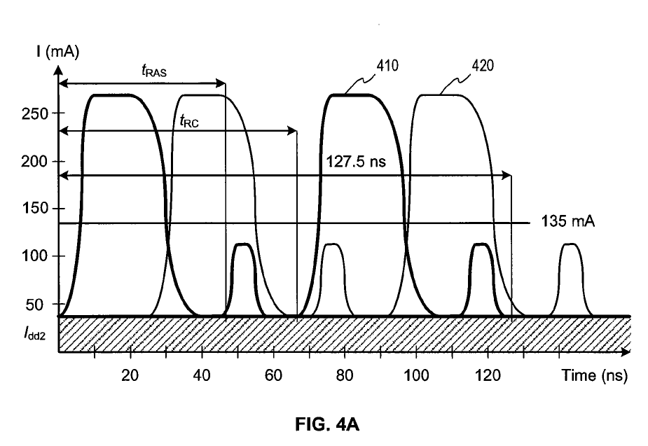

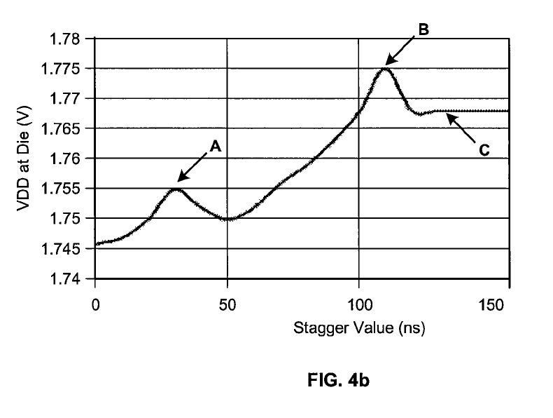

FIG. 4A illustrates current draw as a function of time for two refresh cycles 410 and 420, started independently and staggered by a time period of half of the period of a single refresh cycle.

FIG. 4B illustrates voltage droop on the VDD voltage supply from the nominal voltage of 1.8 volt as a function of a stagger offset for two refresh cycles, according to one embodiment. “Stagger offset” is defined herein as the difference between the starting times of the first and second refresh cycles.

A curve of the voltage droop on the VDD voltage supply from the nominal voltage of 1.8 volt as a function of the stagger offset as shown in FIG. 4B can be generated from simulation models of the interconnect components and the interconnect itself, or can be dynamically calculated from measurements. Three distinct regions become evident in this curve:
A: A local minimum in the voltage droop on the VDD voltage supply from the nominal voltage of 1.8 volt results when the refreshes are staggered by an offset such that the increasing current transient from one refresh event counters the decreasing current transient from another refresh event. The positive slew rate from one refresh produces destructive interference with the negative slew rate from another refresh, thus reducing the effective load.
B: The best case, namely when the droop is minimum, occurs when the current draw profiles have almost zero overlap.
C: Once the waveforms are separated in time so that the refresh cycles do not overlap additional stagger spacing does not offer significant additional relief to the power delivery system. Consequently, thereafter, the level of voltage droop on the VDD supply voltage remains nearly constant.

As can be seen from a simple inspection, the optimal time to begin the second refresh cycle is at the point of minimum voltage droop (highest voltage), point B, which in this example is at about 110 ns. Persons skilled in the art will understand that the values used in the calculations resulting in the curve of FIG. 4B are for illustrative purposes only, and that a large number of other curves with different points of minimum voltage droop are possible, depending on the characteristics of the memory device, and the electrical characteristics of the physical design of the memory subsystem.

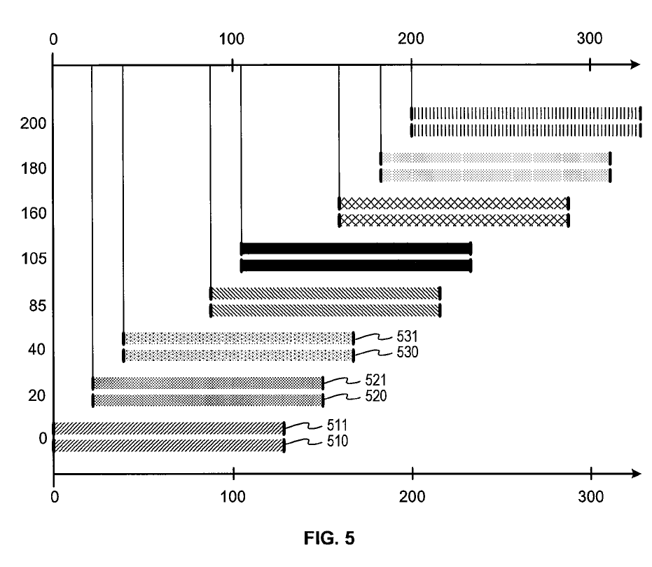

FIG. 5 illustrates the start and finish times of eight independent refresh cycles, according to one embodiment of the present application. The optimization of the start times of successive independent refresh cycles may be accomplished by circuit simulation (e.g., SPICE™ or H-SPICE as sold by Cadence Design Systems) or with logic-oriented timing analysis tools (e.g. Verilog™ as sold by Cadence Design Systems). Alternatively, the start times of the independent refresh cycles may be optimized dynamically through implementation of a dynamic parameter extraction capability. For example, the interface circuit 202 may contain a clock frequency detection circuit that the interface circuit 202 can use to determine the optimal timing for the independent refresh cycles. In the example of FIG. 5, the first independently controlled duple of cycles 510 and 511 begins at time zero. The next independently controlled duple of cycles, cycles 520 and 521, begins approximately at time 25 nS, and the next duple at approximately 37 nSec. In this example, current draw is reduced inasmuch as each next duple of refresh cycles does not begin until such time as the peak current draw of the previous duple has passed. This simplified regime is for illustrative purposes, and one skilled in the art will recognize that other regimes would emerge depending on the characteristic shape of the current draw during a refresh cycle.

In some embodiments, multiple instances of a memory device may be organized to form memory words that are longer than a single instance of the aforementioned memory device. In such a case, it may be convenient to control the independent refresh cycles of the multiple instances of the memory device that form such a memory word with multiple independently controlled memory refresh commands, with a separate refresh command sequence corresponding to each different instance of the memory device.

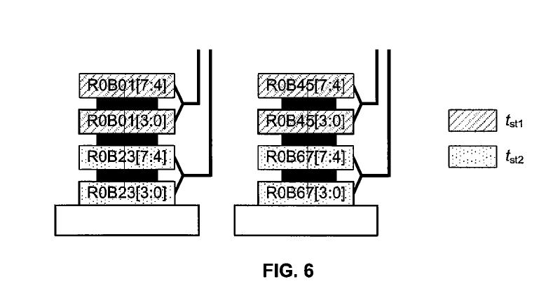

FIG. 6 illustrates a configuration of eight memory devices refreshed by two independently controlled refresh cycles starting at times t_{ST1} and t_{ST2}, respectively, according to one embodiment. The motivation for the refresh schedule is to minimize voltage droop while completing all refresh operations with the allotted time window, as per JEDEC specifications.

As shown, the eight memory devices are organized into two DRAM stacks, and each DRAM stack is driven by two independently controllable refresh command sequences. The memory devices labeled R0B01[7:4], R0B01[3:0], R1B45[7:4], and R1B45[3:0] are refreshed by refresh cycle t_{ST1}, while the remaining memory devices are refreshed by the refresh cycle t_{ST2}.

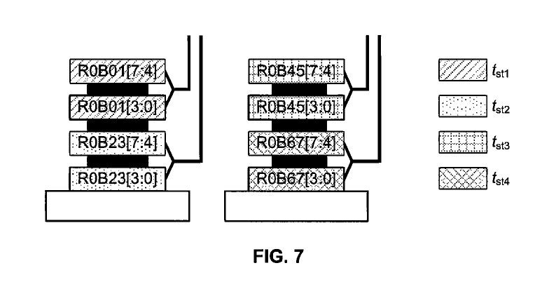

FIG. 7 illustrates a configuration of eight memory devices refreshed by four independently controlled refresh cycles starting at t_{ST1}, t_{ST2}, t_{ST3} and t_{ST4}, respectively, according to another embodiment. Such a configuration is referred to herein as a “quad configuration,” and the stagger offsets in this configuration are referred to as “quad-stagger.” The quad-stagger allows for four independent stagger times distributed over eight devices, thus spreading out the total current draw and lowering large slews that may result from simultaneous activation of refresh cycles in all eight DRAM devices.

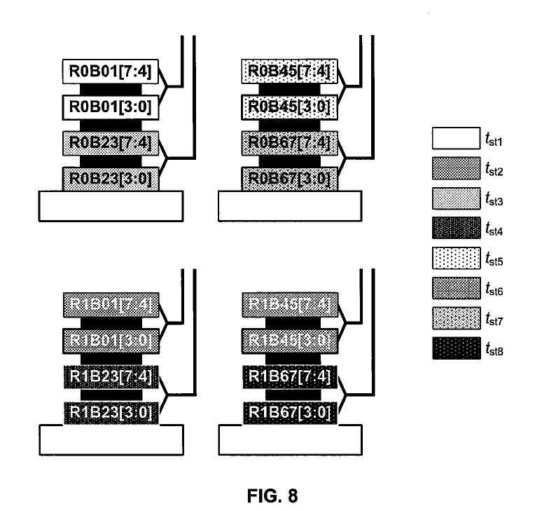

FIG. 8 illustrates a configuration of sixteen memory devices refreshed by eight independently controlled refresh cycles, according to yet another embodiment. Such a configuration is referred to herein as an “octal configuration.” The motivation for this stagger schedule is the same as for the previously mentioned dual and quad configurations, however in the octal configuration it is not possible to complete all refresh operation on all eight memories within the window unless the operations are bunched up more closely than in the quad or dual cases.

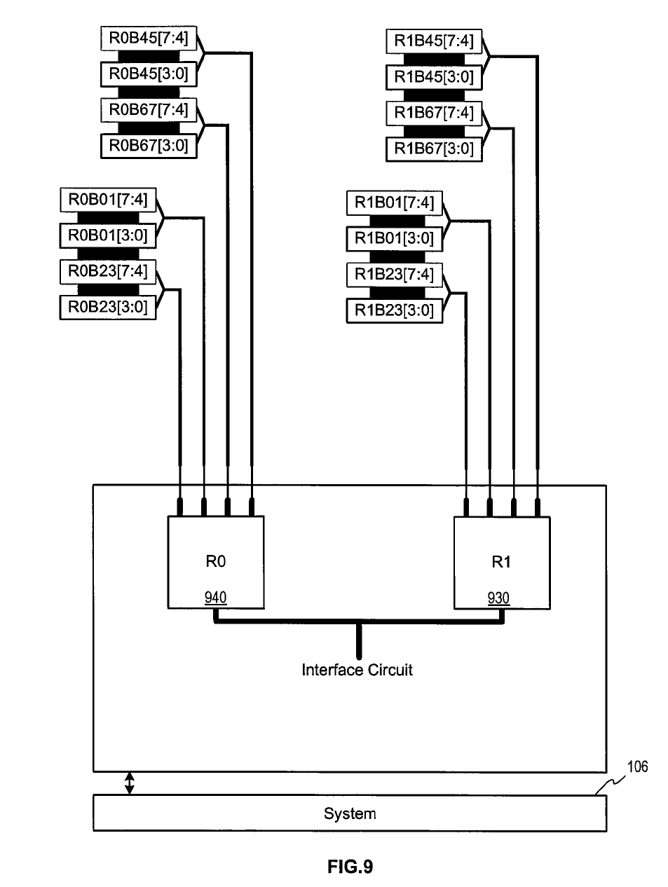

FIG. 9 illustrates the octal configuration of the memory devices of FIG. 8 implemented within the multiple memory device system 100 of FIG. 1A, according to one embodiment. As previously described, the system device 106 is connected to the interface circuit 102, which, in turn, is connected to the memory devices 104A-N. As shown in FIG. 9, there are four independently controllable refresh command sequence outputs of block 930. Outputs of R0 are independently controllable refresh command sequences. Also, outputs of R1 are independently controllable refresh command sequences. The blocks 930, 940, implement their respective functionalities using a combination of logic gates, transistors, finite state machines, programmable logic or any technique capable of operating on or delaying logic or analog signals.

The techniques and exemplary embodiments for how to independently control refresh command sequences to a plurality of memory devices using an interface circuit have now been disclosed. The following describes various techniques for calculating the timing of assertions of the refresh command sequences.

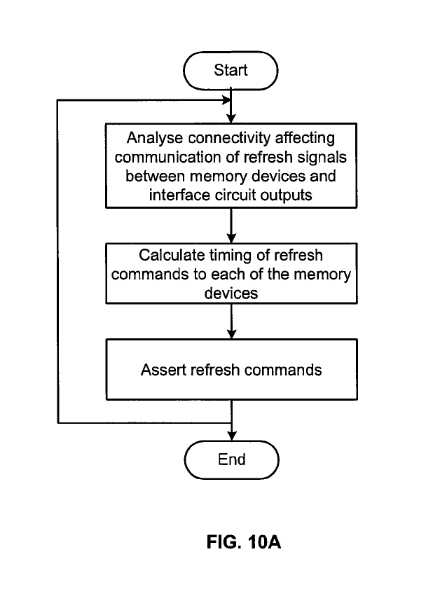

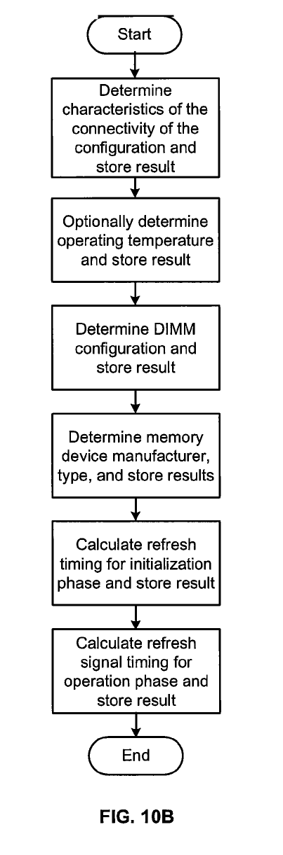

FIG. 10A is a flowchart of method steps for configuring, calculating, and generating the timing and assertion of two or more refresh command sequences, according to one embodiment. Although the method is described with respect to the system of FIG. 1A, persons skilled in the art will understand that any system configured to perform the method steps, in any order, is within the scope of the claims. As shown in FIG. 10A, the method includes the steps of analyzing the connectivity of the refresh command sequences between the memory devices 104 A-N and the interface circuit 102 outputs, calculating the timing of each of the independently controlled refresh command sequences, and asserting each of the refresh command sequences at the calculated time. In exemplary embodiments, one or more of the steps of FIG. 10A are performed in the logic embedded in the interface circuit 102. In another embodiment one or more of the steps of FIG. 10A are performed in the logic embedded in the interface circuit 102 while any remaining steps of FIG. 10A are performed in the intelligent buffer 133.

In one embodiment, analyzing the connectivity of the refresh command sequences between the memory devices 104A-N and the interface circuit 102 outputs is performed statically, prior to applying power to the system device 106. Any number of characteristics of the system device 106, motherboard, trace-length, capacitive loading, memory type, interface circuit output buffers, or other physical design characteristics, may be used in an analysis or simulation in order to analyze or optimize the timing of the plurality of independently controllable refresh command sequences.

In another embodiment, analyzing the connectivity of the refresh command sequences between the memory devices 104A-N and the interface circuit 102 outputs is performed dynamically, after applying power to the system device 106. Any number of characteristics of the system device 106, motherboard, trace-length, capacitive loading, memory type, interface circuit output buffers, or other physical design characteristics, may be used in an analysis or simulation in order to analyze or optimize the timing of the plurality of independently controllable refresh command sequences.

In some embodiments of the multiple memory device system of FIG. 1A, the physical design can have a significant impact on the current draw, voltage droop, and staggering of the multiple independently controlled refresh command sequences. A designer of a DIMM, motherboard, or system would seek to minimize spikes in current draw, the resulting voltage droop on the VDD voltage supply, and still meet the required refresh cycle time. Some rules and guidelines for the physical design of the trace lengths and capacitance for the signals 108, and for the packaging of the memory circuits 104A-104N as related to refresh staggering include:
Reduce the inductance between intelligent buffer 133 and each memory device 132A-N, between intelligent buffer 133 and the intelligent register 102.
Increase decoupling capacitance between VDD and VSS at all levels of the PDS: PCB, BGA, substrate, wirebond, RDL and die.
Separate the spikes in current draw by staggering the refresh times between multiple memory devices.

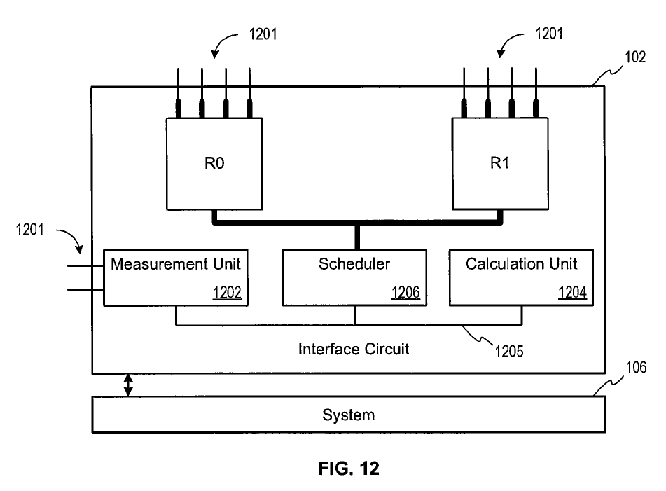

In another embodiment, configuring the connectivity of the refresh command sequences between the memory devices 104A-N and the interface circuit 102 outputs is performed periodically at times after application of power to the system device 106. Dynamic configuration uses a measurement unit (e.g., element 1202 of FIG. 12) that is capable of performing a series of analog and logic tests on one or more of various pins of the interface circuit 102 such that actual characteristics of the pin is measured and stored for use in refresh scheduling calculations. Examples of such characteristics include, but are not limited to timing of response at first detected voltage change, timing of response where detected voltage change crosses the logic_{—}1/logic_{—}0 threshold value, timing of response at peak detected voltage change, duration and amplitude of response ring, operating frequency of the interface circuit and operating frequency of the DRAM devices etc.

FIG. 10B shows steps of a method to be performed periodically at some time after application of power to the system device 106. The steps include determining the connectivity characteristics of the affecting communication of the refresh commands, determining operating conditions, including one or more temperatures, determining the configuration of the memory (e.g. size, number of ranks, memory word organization, etc.), calculating the refresh timing for initialization, and calculating refresh timing for the operation phase. Similarly to the method of 10A, the method of 10B may be applied repeatedly, beginning at any step, in an autonomous fashion or based on any technically feasible event, such as a power-on reset event or the receipt of a time-multiplexed or other signal, a logical combination of signals, a combination of signals and stored state, a command or a packet from any component of the host system, including the memory controller.

In embodiments where one or more temperatures are measured, the calculation of the refresh timing considers not only the measured temperatures, but also the manufacturer's specifications of the DRAMs

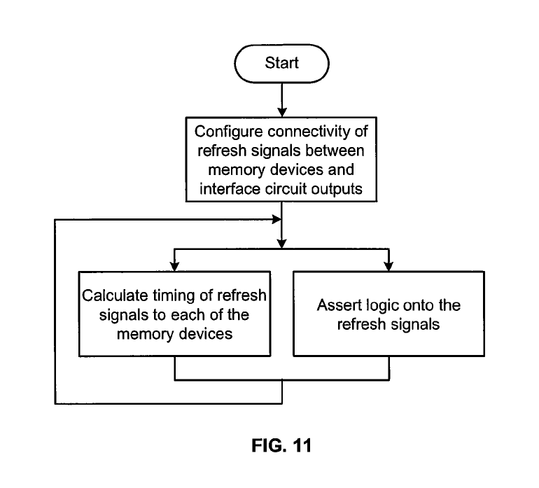

FIG. 11 is a flowchart of method steps for analysing, calculating, and generating the timing and assertion of two or more refresh command sequences continuously and asynchronously, according to one embodiment. Although the method is described with respect to the systems of FIGS. 1A, 1B, 1C, and FIG. 12, persons skilled in the art will understand that any system configured to implement the method steps in any order, is within the scope of the claims. As shown in FIG. 11, the method includes the steps of continuously and asynchronously analysing the connectivity affecting the assertion of refresh commands between the memory devices 104A-N and the interface circuit 102 outputs, continuously and asynchronously calculating the timing of each of the independently controlled refresh command sequences, and continuously and asynchronously scheduling the assertion of each of the refresh command sequences at the calculated time. In one embodiment, the method steps of FIG. 11 may be implementation in hardware. Those skilled in the art will recognize that physical characteristics such as capacitance, resistance, inductance and temperature may vary slightly with time and during operation, and such variations may affect scheduling of the refresh commands. Moreover, during operation, the assertion of refresh commands is intended to continue on a schedule that is not in violation of any schedule required by the DRAM manufacturer, therefore the step of calculating timing of refresh command sequences and may operate concurrently with the step of asserting refresh command sequences.

FIG. 12 illustrates the interface circuit 102 of FIG. 1A with refresh command sequence outputs 1201 adapted to connect to a plurality of memory devices, such as the memory devices 104A-N of FIG. 1A, according to one embodiment. In this embodiment, each of a measurement unit 1202, a calculation unit 1204, and a scheduler 1206 is configured to operate continuously and asynchronously.

The measurement unit 1202 is configured to generate signals 1205 and to sample analog values of inputs 1203 either autonomously at some time after power-on or upon receiving a command from the system device 106. The measurement unit 1202 also is operable to determine the configuration of the memory devices 104A-N (not shown). The configuration determination and measurements are communicated to the calculation unit 1204. The calculation unit 1204 analyses the measurements received from the measurement unit 1202 and calculates the optimized timing for staggering the refresh command sequences, as previously described herein.

Understanding the use of the disclosed techniques for managing refresh commands, there are many apparent embodiments based upon industry-standard configurations of DRAM devices.

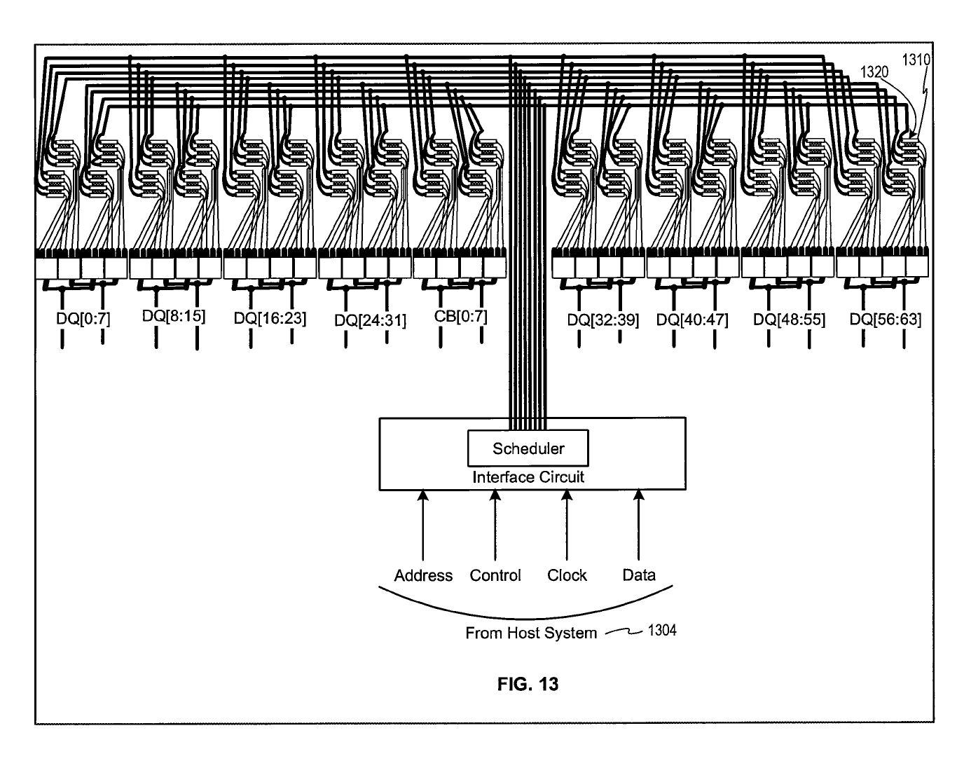

FIG. 13 is an exemplary illustration of a 72-bit ECC (error-correcting code) DIMM based upon industry-standard DRAM devices 1310 arranged vertically into stacks 1320 and horizontally into an array of stacks, according to one embodiment. As shown, the stacks of DRAM devices 1320 are organized into an array of stacks of sixteen 4-bit wide DRAM devices 1310 resulting in a 72-bit wide DIMM. Persons skilled in the art will understand that many configurations of the ECC DIMM of FIG. 13 may be possible and envisioned. A few of the exemplary configurations are further described in the following paragraphs.

In another embodiment, the configuration contains N DRAM devices, each of capacity M that—in concert with the interface circuit(s) 1470—emulates one DRAM devices, each of capacity N*M. In a system with a system device 1420 designed to interface with a DRAM device of capacity N*M, the system device will allow for a longer refresh cycle time than it would allow to each DRAM device of capacity M. In this configuration, when a refresh command is issued by the system device to the interface circuit, the interface circuit will stagger N numbers of refresh cycles to the N numbers of DRAM devices. In one optional feature, the interface circuit may use a user-programmable setting or a self calibrated frequency detection circuit to compute the optimal stagger spacing between each of the N numbers of refresh cycles to each of the N numbers of DRAM devices. The result of the computation is minimized voltage droop on the power delivery network and functional correctness in that the entire sequence of N staggered refresh events are completed within the refresh cycle time expected by the system device. For example, a configuration may contain 4 DRAM devices, each 1 gigabit in capacity that an interface circuit may use to emulate one DRAM device that is 4 gigabit in capacity. In a JEDEC compliant DDR2 memory system, the defined refresh cycle time for the 4 gigabit device is 327.5 nanoseconds, and the defined refresh cycle time for the 1 gigabit device is 127.5 nanoseconds. In this specific example, the interface circuit may stagger refresh commands to each of the 1 gigabit DRAM devices with spacing that is carefully selected based on the operating characteristics of the system, such as temperature, frequency, and voltage levels, while still ensuring that that the entire sequence is complete within the 327.5 ns expected by the memory controller.

In another embodiment, the configuration contains 2*N DRAM devices, each of capacity M that—in concert with the interface circuit(s) 1470—emulates two DRAM devices, each of capacity N*M. In a system with a system device 1420 designed to interface with a DRAM device of capacity N*M, the system device will allow for a longer refresh cycle time than it would allow to each DRAM device of capacity M. In this configuration, when a refresh command is issued by the system device to the interface circuit to refresh one of the two emulated DRAM devices, the interface circuit will stagger N numbers of refresh cycles to the N numbers of DRAM devices. In one optional feature when the system device issues the refresh command to the interface circuit to refresh both of the emulated DRAM devices, the interface circuit will stagger 2*N numbers of refresh cycles to the 2*N numbers of DRAM devices to minimize voltage droop on the power delivery network, while ensuring that the entire sequence completes within the allowed refresh cycle time of the single emulated DRAM device of capacity N*M.

As can be understood from the above discussion of the several disclosed configurations of the embodiments of FIG. 13, there exist at least as many refresh command sequence spacing possibilities as there are possible configurations of DRAM memory devices on a DIMM.

The response of a memory device to one or more time-domain pulses can be represented in the frequency domain as a spectrograph. Similarly, the power delivery system of a motherboard has a natural frequency domain response. In one embodiment, the frequency domain response of the power delivery system is measured, and the timing of refresh command sequence for a DIMM configuration is optimized to match the natural frequency response of the power delivery subsystem. That is, the frequency domain characteristics between the power delivery system and the memory device on the DIMM are anti-correlated such that the energy of the pulse stream of refresh command sequences spread the energy of the pulse stream out over a broad spectral range. Accordingly one embodiment of a method for optimizing memory refresh command sequences in a DIMM on a motherboard is to measure and plot the frequency domain response of the motherboard power delivery system, measure and plot the frequency domain response of the memory devices, superimpose the two frequency domain plots and define a refresh command sequence pulse train which frequency domain response, when superimposed on the aforementioned plots results in a flatter frequency domain response.

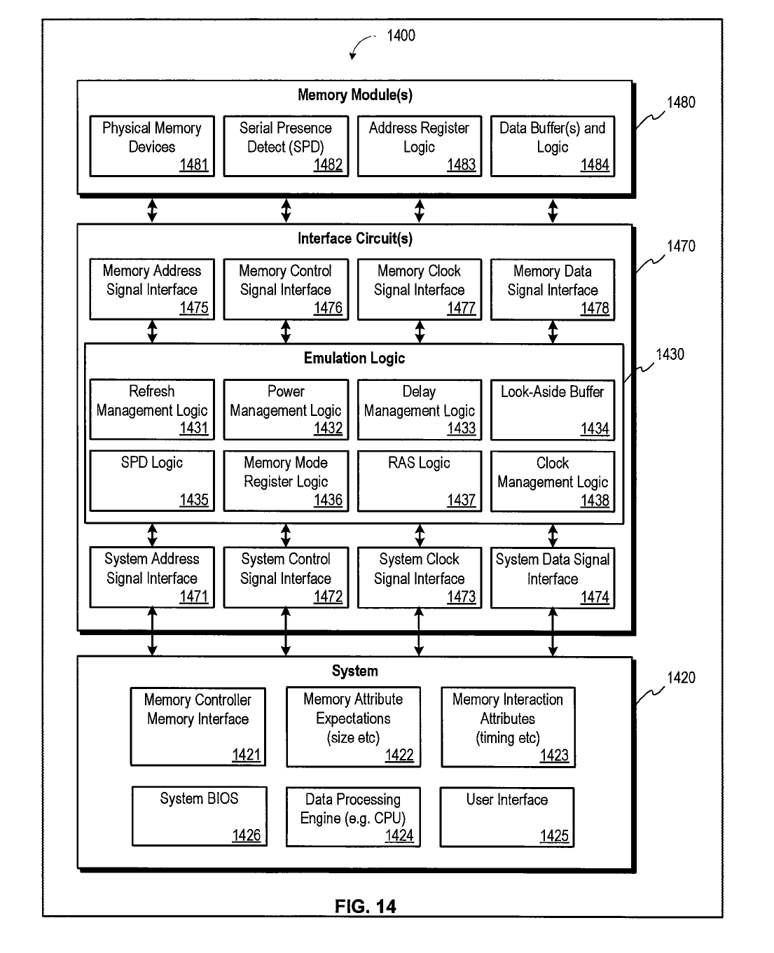

FIG. 14 is a conceptual illustration of a computer platform 1400 configured to implement one or more aspects of the embodiments. As an option, the contents of FIG. 14 may be implemented in the context of the architecture and/or environment of the figures previously described herein. Of course, however, such contents may be implemented in any desired environment.

As shown, the computer platform 1400 includes, without limitation, a system device 1420 (e.g., a motherboard), interface circuit(s) 1470, and memory module(s) 1480 that include physical memory devices 1481 (e.g., physical memory devices, such as the memory devices 104A-N shown in FIG. 1A). In one embodiment, the memory module(s) 1480 may include DIMMs. The physical memory devices 1481 are connected directly to the system 1420 by way of one or more sockets.

In one embodiment, the system device 1420 includes a memory controller 1421 designed to the specifics of various standards, in particular the standard defining the interfaces to JEDEC-compliant semiconductor memory (e.g., DRAM, SDRAM, DDR2, DDR3, etc.). The specifications of these standards address physical interconnection and logical capabilities. FIG. 14 depicts the system device 1420 further including logic for retrieval and storage of external memory attribute expectations 1422, memory interaction attributes 1423, a data processing engine 1424, various mechanisms to facilitate a user interface 1425, and the system basic Input/Output System (BIOS) 1426.

In various embodiments, the system device 1420 may include a system BIOS program capable of interrogating the physical memory module 1480 (e.g., DIMMs) as a mechanism to retrieve and store memory attributes. Furthermore, in external memory embodiments, JEDEC-compliant DIMMs include an EEPROM device known as a Serial Presence Detect (SPD) 1482 where the DIMM's memory attributes are stored. It is through the interaction of the system BIOS 1426 with the SPD 1482 and the interaction of the system BIOS 1426 with the physical attributes of the physical memory devices 1481 that the various memory attribute expectations and memory interaction attributes become known to the system device 1420. Also optionally included on the memory module(s) 1480 are an address register logic 1483 (e.g. JEDEC standard register, register, etc.) and data buffer(s) and logic 1484.

In various embodiments, the compute platform 1400 includes one or more interface circuits 1470, electrically disposed between the system device 1420 and the physical memory devices 1481. The interface circuits 1470 may be physically separate from the DIMM, may be placed on the memory module(s) 1480, or may be part of the system device 1420 (e.g., integrated into the memory controller 1421, etc.)

Some characteristics of the interface circuit(s) 1470, in accordance with an optional embodiment, includes several system-facing interfaces such as, for example, a system address signal interface 1471, a system control signal interface 1472, a system clock signal interface 1473, and a system data signal interface 1474. Similarly, the interface circuit(s) 1470 may include several memory-facing interfaces such as, for example, a memory address signal interface 1475, a memory control signal interface 1476, a memory clock signal interface 1477, and a memory data signal interface 1478.

In additional embodiments, an additional characteristic of the interface circuit(s) 1470 is the optional presence of one or more sub-functions of emulation logic 1430. The emulation logic 1430 is configured to receive and optionally store electrical signals (e.g., logic levels, commands, signals, protocol sequences, communications) from or through the system-facing interfaces 1471-1474 and to process those signals. In particular, the emulation logic 1430 may contain one or more sub functions (e.g., power management logic 1432 and delay management logic 1433) configured to manage refresh command sequencing with the physical memory devices 1481.

Aspects of embodiments of the invention can be implemented in hardware or software or both, with the software being delivered as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; and (ii) writable storage media (e.g., floppy disks within a diskette drive or hard-disk drive) on which alterable information is stored. Such computer-readable storage media, when carrying computer-readable instructions that direct the functions disclosed herein, are yet further embodiments.

While the foregoing is directed to exemplary embodiments, other and further embodiments may be devised without departing from the basic scope thereof.

We Claim:

1. A method for generating staggered refresh commands for two or more memory devices, the method comprising:
analyzing a connectivity for transmitting refresh signals between an interface circuit and the two or more memory devices;
calculating a timing for issuing staggered refresh command to the two or more memory devices based on a refresh command received from a memory controller and the analyzed connectivity; and
asserting the staggered refresh commands to the two or more memory devices at the calculated times.

2. The method of claim 1, wherein the step of analyzing is performed statically, prior to applying power to a system device coupled to the memory controller.

3. The method of claim 1, wherein the step of analyzing is performed dynamically, after applying power to a system device coupled to the memory controller.

4. The method of claim 1, wherein the step of analyzing is performed periodically, after applying power to a system device coupled to the memory controller.

5. The method of claim 4, wherein the step of analyzing comprises determining characteristics of a configuration of the connectivity between the interface circuit and the two or more memory devices.

6. The method of claim 5, wherein the interface circuit is directly coupled to a memory module, and the step of analyzing further comprises determining a configuration of the memory module.

7. The method of claim 6, wherein the memory module comprises a dual in-line memory module.

8. The method of claim 6, wherein the step of analyzing further comprises determining the manufacturer of the two or more memory devices.

9. The method of claim 8, wherein the step of analyzing further comprises determining an operating temperature.

10. The method of claim 8, wherein the step of calculating comprises calculating a refresh signal timing for an initialization phase.

11. The method of claim 10, wherein the step of calculating further comprises calculating a refresh signal timing for an operation phase.

12. The method of claim 1, wherein the steps of calculating and asserting are performed asynchronously.

13. The method of claim 1, wherein the steps of analyzing, calculating and asserting are performed by logic included in the interface circuit.

14. The method of claim 1, wherein at least one of the steps of analyzing, calculating and asserting is performed by logic included in the interface circuit, and the other steps are performed by an intelligent buffer coupled to the interface circuit.

15. The method of claim 1, wherein the step of analyzing comprises performing a series of analog and logic tests to measure pin characteristics of the two or more memory devices.

16. The method of claim 15, wherein the measured pin characteristics include a timing of response related to when voltage change crosses logical 1 and logical 0 thresholds.

17. The method of claim 15, wherein the measured pin characteristics include a timing response related to a peak detected voltage change.

18. The method of claim 17, wherein the measured pin characteristics include a signal response ringing.

19. A computer-readable medium including instructions that when executed by a processing unit cause the processing unit to generate staggered refresh commands for two or more memory devices, by performing the steps of:
analyzing a connectivity for transmitting refresh signals between an interface circuit and the two or more memory devices;
calculating a timing for issuing staggered refresh command to the two or more memory devices based on a refresh command received from a memory controller and the analyzed connectivity; and
asserting the staggered refresh commands to the two or more memory devices at the calculated times.

20. The computer-readable medium of claim 19, wherein the step of analyzing is performed statically, prior to applying power to a system device coupled to the memory controller.

21. The computer-readable medium of claim 19, wherein the step of analyzing is performed dynamically, after applying power to a system device coupled to the memory controller.

22. The computer-readable medium of claim 19, wherein the step of analyzing is performed periodically, after applying power to a system device coupled to the memory controller.

23. The computer-readable medium of claim 22, wherein the step of analyzing comprises determining characteristics of a configuration of the connectivity between the interface circuit and the two or more memory devices.

24. The computer-readable medium of claim 23, wherein the interface circuit is directly coupled to a memory module, and the step of analyzing further comprises determining a configuration of the memory module.

25. The computer-readable medium of claim 24, wherein the memory module comprises a dual in-line memory module.

26. The computer-readable medium of claim 25, wherein the step of analyzing further comprises determining the manufacturer of the two or more memory devices.

27. The computer-readable medium of claim 26, wherein the step of analyzing further comprises determining an operating temperature.

28. The computer-readable medium of claim 26, wherein the step of calculating comprises calculating a refresh signal timing for an initialization phase.

29. The computer-readable medium of claim 28, wherein the step of calculating further comprises calculating a refresh signal timing for an operation phase.

30. The computer-readable medium of claim 19, wherein the steps of calculating and asserting are performed asynchronously.
